(19) United States
(12) Patent Application Publication
(10) Pub. No.: US 2009/0070262 A1
(43) Pub. Date: Mar. 12, 2009

(54) ACH-ENABLED MICROPAYMENTS

(75) Inventors: Hugo Olliphant, San Francisco, CA (US); David Gausebeck, Mountain View, CA (US); Vishwanath Shastry, Palo Alto, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., San Jose, CA (US)

(21) Appl. No.: 11/853,962

(22) Filed: Sep. 12, 2007

(51) Int. Cl. G06Q 40/00; G06F 17/30; G06F 17/40

(52) U.S. Cl. 705/44; 705/35

(57) ABSTRACT

A method and a system for arranging for micropayment of transaction amounts related to micro-transactions transacted by a user are provided. In example embodiments, the method may include analyzing transaction conditions (e.g., availability of a stored value, a valid bank account, an Automated Clearing House (ACH) funding, a credit card account, or a transaction risk assessment result, associated with the user, and monetary value of the micro-transaction) and selecting a micropayment option for charging the transaction amount from a group of micropayment options, based on the transaction condition. The method may also include automatically applying the selected micropayment option for charging the transaction amount. According to example embodiments, the system may include a transaction analysis module and a payment processor.

### TECHNICAL FIELD

Example embodiments relate generally to the technical field of electronic payment processing, and in one specific example, to a system to arrange for automatic funding of micro-transactions using multiple sources including Automated Clearing House micropayments.

### BACKGROUND

The Internet and the World Wide Web (“Web”) have altered the landscape of information delivery and affected numerous aspects of life, including commerce and entertainment. This technological development has enabled individuals to participate in various business transactions within an Internet marketplace. In these online transactions, electronic payments between transacting parties have become increasingly prevalent as the accessibility of the technology to enable such payments has increased. Network-based vendors typically depend on electronic payment services and may accept a number of electronic payment instruments (e.g., credit cards, debit cards, etc.) and other electronic payment services such as the PayPal online payment service.

Typically, electronic payment services (e.g., credit cards, such as Visa, MasterCard, and American Express, or services such as, PayPal, etc.) charge for the provision of the services, based on per-transaction basis. These transaction charges, which often include fixed charges, are a financial burden on the vendors, as they are typically levied against vendors that are providing the goods or services. In cases where the transaction charge is small, compared to the transaction value, the benefits to both trading parties may outweigh the relevant cost. However, when the transaction values are small the electronic payment transaction charges make them unattractive to vendors. For example, consider online electronic content (e.g., MP3 file) offered for less than $1. Assuming a per transaction charge of $0.10, the vendor may be reluctant to accept an electronic payment that consumes 10% of the total transaction value. Transaction charges associated with payment services for such micro-transactions may remain as prohibitive factors, unless intelligent systems for proper handling of so-called “micropayments” are available.

### BRIEF DESCRIPTION OF THE DRAWINGS

Some embodiments are illustrated by way of example and not limitation in the figures of the accompanying drawings in which:

FIG. 1 is a high level diagram depicting an example embodiment of a micro-transaction environment including a user and a business entity, using a micropayment system;

FIG. 2 is a block diagram illustrating an example embodiment of a micro-transaction system, including example modules;

FIG. 3 is a flow diagram illustrating an example embodiment of a method for arranging automatic funding of micropayments;

FIG. 4 is a flow diagram depicting an example embodiment of an algorithm for selecting amongst multiple funding sources to enable a micropayment;

FIG. 5 is a diagram illustrating another example embodiments of a method for enabling a micropayment;

FIG. 6 is high level block diagram illustrating an example embodiment of a network-based commerce system using micro-transaction applications to enable micropayments;

FIG. 7 is an example group of marketplace and micropayment applications used by the network-based commerce system of FIG. 6; and

FIG. 8 is a block diagram illustrating a diagrammatic representation of a machine in the example form of a computer system.

### DETAILED DESCRIPTION

Example methods and systems for arranging for micropayment of transaction amounts related to micro-transactions transacted by a user have been described. In the following description, for purposes of explanation, numerous specific details are set forth in order to provide a thorough understanding of example embodiments. It will be evident, however, to one skilled in the art that the present invention may be practiced without these specific details.

A method for arranging for micropayment of transaction amounts related to micro-transactions transacted by a user is described. The method may involve applying multiple sources (e.g., a wallet concept) to fund a micro-transaction, where the selection among the sources may be made automatically, based on certain criteria. The sources may include, inter alia, stored value, low-cost funding sources such as Automated Clearing House (ACH), and aggregation (e.g., accumulating charges until the total amount of charges or the number of charges reaches a predefined value and then charging the total amount at the same time), as discussed in detail below. The method may facilitate handling of payments by electronic payment services for transaction amounts associated with micro-transactions. This may result in increased market activity in the business of online content (e.g., MP3, and video), especially a youthful client base, among teenagers and young adults.

In example embodiments, the method may include arranging for micropayment of transaction amounts related to micro-transactions transacted by a user. The method may include analyzing one or more transaction conditions and selecting a micropayment option for charging the transaction amount, from a group of micropayment options, based on the transaction conditions. The method may also include automatically applying the selected micropayment option for charging the transaction amount.

In an example embodiment, the transaction conditions may include availability of a stored value, availability of a valid bank account associated with the user, availability of an ACH funding to the user, monetary value of the micro-transaction, availability of a credit card account associated with the user, and a transaction risk assessment result.

An example group of micropayment options may include a stored value, a credit card charge, a balance transfer, an ACH funding, an aggregation, or a forced pre-funding. For example, the method may determine that a stored value for the user is available and, based on the determination, deduct the transaction amount from the stored value. The stored value, in the context of the present application, may be in the form of a prepaid card, e.g., a gift card, a gift certificate, a payroll card etc.

According to example embodiments, the method may determine that a valid credit card account associated with the user is available and based on the determination, charge the transaction amount to the valid credit card account. In a case where it is determined that a valid credit card account associated with the user is unavailable, the method may force the user to upgrade to an ACH funding. The method may also determine that a valid bank account associated with the user is available and, based on the determination, apply an instant balance transfer from the valid bank account associated with the user.

In alternative embodiments, the method may determine that an ACH funding is available to the user and, based on the determination, apply the ACH funding. The method may further determine that the user has a positive transaction risk assessment result and, based on the determination, apply the aggregation method for funding the transaction.

In yet another example embodiment, the method may determine that a valid bank account associated with the user is available to the user and the user has a positive transaction risk assessment result. Based on the determination, the method may apply a delayed balance transfer from the bank account. In case it is determined that the user has a negative transaction risk assessment result, the method may apply a forced pre-funding. The forced pre-funding may include forcing the user to provide a funding source for a predefined minimum charge, e.g. $10, before proceeding with the transaction.

### System Architecture

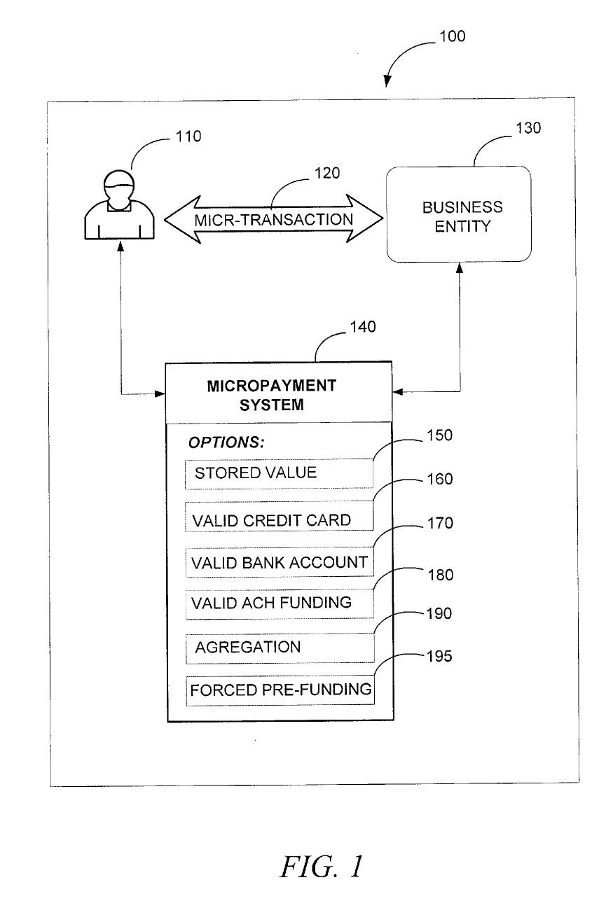

FIG. 1 is a high level diagram depicting an example embodiment of a micro-transaction environment 100 including a user and a business entity, using a micropayment system. The example micro-transaction environment 100 may include a user 110, a business entity 130 and a micropayment system 140. The user 110 may engage in a micro-transaction 120 with the business entity 130. In example embodiments, the business entity 130 may include e-commerce vendors, such as online content providers, e.g., MP3 or online video providers.

The business entity 130 may rely on the micro-payment system 140 to arrange for the payment of the micro-transaction 120. The micro-payment system 140 may analyze transaction conditions and, based on the transaction conditions, apply a micro-payment option for charging the transaction amount. The micro-payment options may include stored value 150, valid credit card account 160, valid bank account 170, valid ACH funding 180, aggregation 190, and forced pre-funding 195.

According to example embodiments, the stored value 150, in the context of the present application, may be in the form of a prepaid card, e.g., a gift card, a gift certificate, a payroll card etc. The aggregation 190 may constitute accumulating charges until the total amount of charges or the number of charges reaches a predefined value and then charging the total amount at the same time. The forced pre-funding 195 may amount to forcing the user to provide a funding source for a predefined minimum charge, e.g. $10, before proceeding with the transaction.

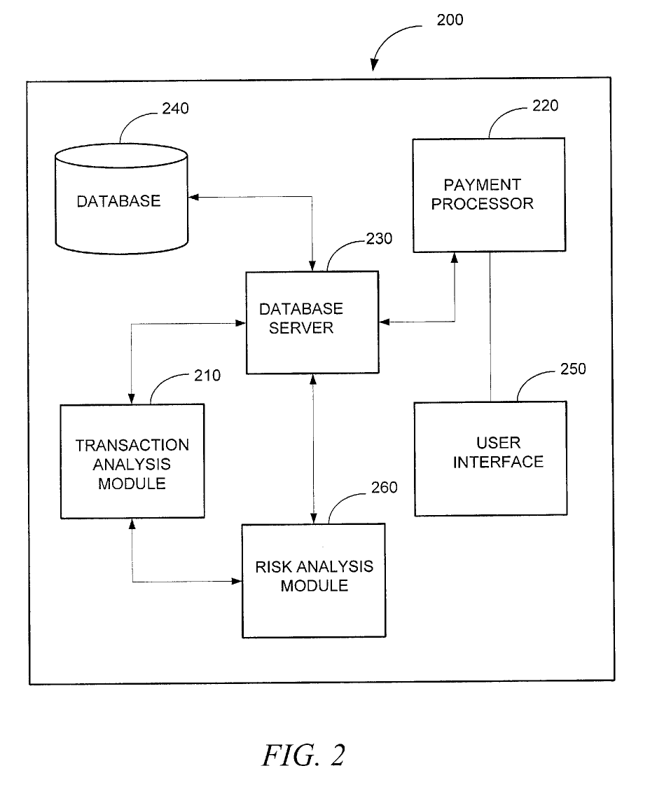

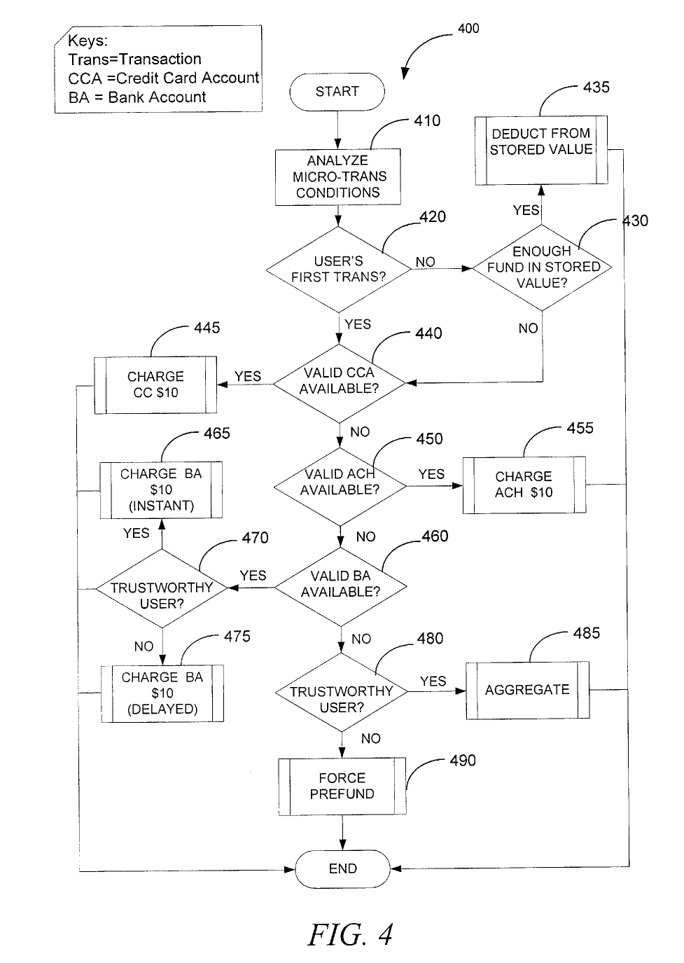

FIG. 2 is a block diagram illustrating an example embodiment of a micro-transaction system 200, including example modules. In one example embodiment, the micro-transaction system 200 may include a transaction analysis module 210, a payment processor 220, a database server 230, a database 240, a user interface 250 and a risk analysis module 260. Referring now to FIGS. 1 and 2, once the user 110 has initiated a micro-transaction 120 with a business entity 130, transaction analysis module 210 may analyze the transaction conditions stored in the database 240 and, based on the transaction conditions, select a micro-payment option (e.g., stored value 150, valid credit card account 160, valid bank account 170, valid ACH funding 180, aggregation 190 or forced pre-funding 195). The micropayment selection process will be discussed in detail below in reference to FIG. 4.

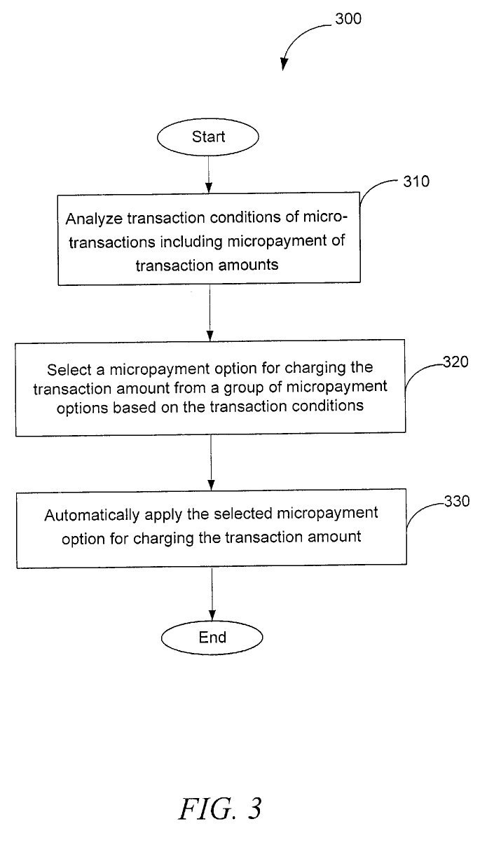

FIG. 3 is a flow diagram illustrating an example embodiment of a method 300 for arranging automatic funding of micropayments. The method 300 starts at operation 310, where the transaction analysis module 210 may analyze the transaction conditions of a micro-transaction retrieved from the database 240 via the database server 230. The micro-transaction may include micropayment of transaction amounts. The transaction conditions may include availability of a stored value 150, availability of a valid bank account 170 associated with the user, availability of an ACH funding 180 to the user, monetary value of the micro-transaction 120, availability of a valid credit card account 160 associated with the user, or a transaction risk assessment result.

In an example embodiment, the payment processor 220, at operation 320, may select a micro-payment option for charging the transaction amount from a group of micro-payment options based on the transaction conditions analyzed by the transaction analysis module 210. Once the micro-payment option is selected, at operation 330, the payment processor 220 may automatically apply the selected micro-payment option for charging the transaction amount.

FIG. 4 is a flow diagram depicting an example embodiment of an algorithm 400 for selecting amongst multiple funding sources to enable a micropayment. The algorithm 400 depicts an example embodiment of how the transaction analysis module 210 may make a decision about selecting among various micro-payment options and how the options are implemented by the payment processor 220.

At operation 410, the transaction analysis module 210 may use the information stored in the database 240 to analyze the conditions for micro-transaction payments. At control operation 420, if the analysis result shows that it is the user's first transaction, then the control is passed to the control operation 440. If the user 110 has previously transacted with the business entity 130, then the control is transferred to the control operation 430. If the user 110 is not a new user transacting for the first time with the business entity 130, the user may have stored value 150 for funding the transaction amount.

At control operation 430, if it is decided that the money left in the stored value 150 is sufficient to fund the micro-transaction 120, then at operation 435, the transaction amount may be deducted from the stored value 150. If the existing stored value 150 does not have enough money left to fund the transaction amount, the control is passed to the control operation 440.

At control operation 440, the transaction analysis module 210 may determine that there is a valid credit card account 160 associated with the user 110. In that case, at operation 445, the payment processor 220 may charge the valid credit card account 160 for a pre-defined value e.g., $10, or the transaction amount if the user 110 is a returning customer. The charged amount may be used for the later transactions with the business entity 130, transacted by the user 110. However, if the transaction analysis module 210 finds that there is no valid credit card account available, the control is transferred to control operation 450.

At control operation 450, the transaction analysis module may verify that there is a valid ACH funding 180 available. If an ACH funding 180 is available, the payment processor 220 may, at operation 455, charge the ACH account for a pre-defined amount, e.g., $10, or the transaction amount if the user 110 is a returning customer. In case the ACH funding 180 is not available, the control may be transferred to operation 460. At operation 460, the transaction analysis module 210 may determine whether a valid bank account 170 associated to the user is available. If such an account is available, and at control operation 470, it is established that the user is trustworthy, the available bank account 170 is instantly charged for a predefined value, e.g., $10 or the transaction amount if the user 110 is a returning customer. (Operation 465).

The assessment of the trustworthiness of the user 110 may be performed by the risk analysis module 260 which may use the information related to the user 110 stored in the database 240, or may utilize other professional entities to profile the user in order to make the risk assessment. According to an example embodiment, the transaction itself may be checked for trustworthiness. For example, a low-risk, high-margin, intangible good priced at $0.25 may be trusted for aggregation, whereas in the case of a lower margin item such as a digital music where royalties may have to be paid, the transaction may not qualify as trusted for aggregation.

Referring to control operation 470, if the user 110 turns out to be untrustworthy, at operation 475 the charging of the predefined value, e.g., $10, or the transaction amount if the user 110 is a returning customer, to the existing bank account 170 may be delayed.

Returning to control operation 460, if it is determined that the valid bank account 170 is not available; the control may be passed to control operation 480. At this operation, the risk analysis module 260 may analyze the trustworthiness of the user 110. If the user was found to be trustworthy, at operation 485, the payment processor 220 may use the aggregate option 190 to fund the transaction.

However, if it turns out that the user 110 is not trustworthy; at operation 490 the payment processor 220 may implement a forced pre-funding option 195. For that, the payment processor 220 may communicate with the user 110 via the user interface 250 and request that the user 110 provide a funding source for a predefined amount e.g. $10.

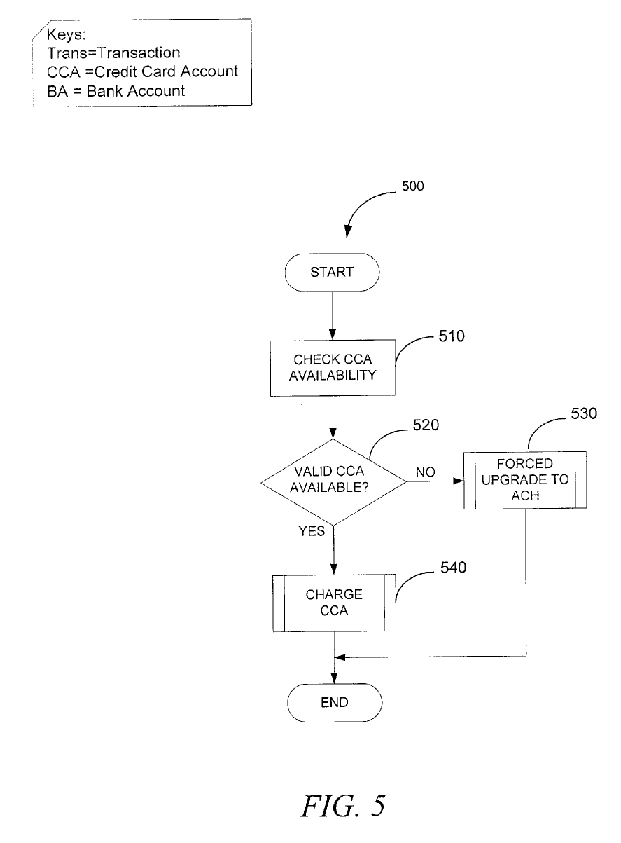

FIG. 5 is a diagram illustrating another example embodiment of a method 500 for enabling a micropayment. The method 500 depicts an alternative embodiment to the method of FIG. 4, in which at operation 510, it is checked whether a valid credit card account 160 is available to the user 110. If at control operation 520 it is established that a valid credit card account 160 is not available; the payment processor 220 may communicate with the user 110 via the user interface 250 and request the user 110 to upgrade to an ACH funding 180 (operation 530).

However, if the valid credit card 160 is available to the user 110, at operation 540 the valid credit card account 160 may be charged for a predefined amount, e.g., $10, or the transaction amount if the user 110 is a returning customer.

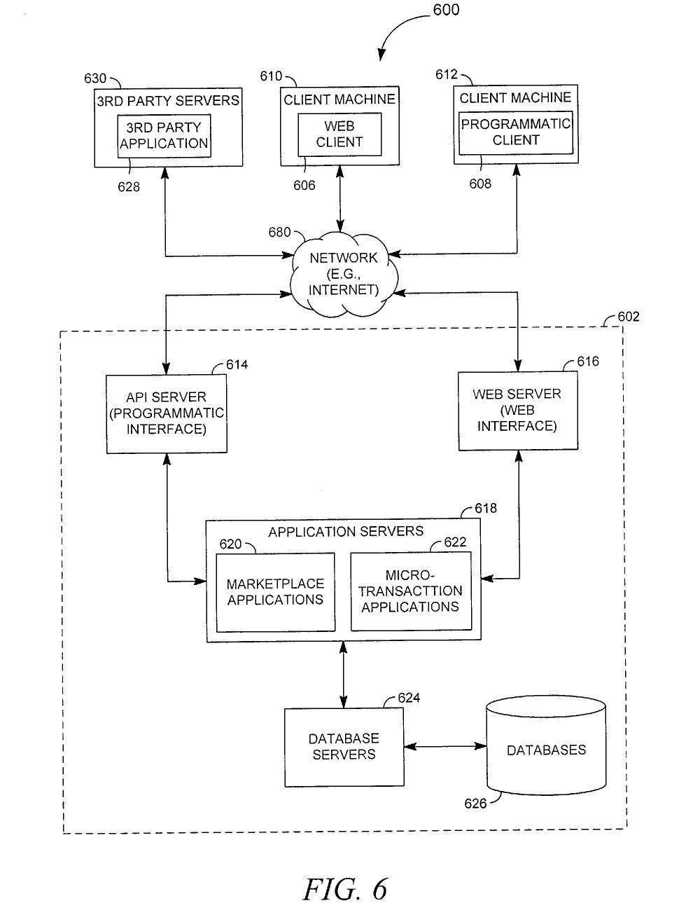

FIG. 6 is high-level block diagram illustrating an example embodiment of a network-based commerce system 600 having a client-server architecture and using education and promotion to improve online reputation. A commerce platform, in the example form of a network-based marketplace 602, provides server-side functionality via a network 680 (e.g., the Internet) to one or more clients. FIG. 6 illustrates, for example, a web client 606 (e.g., a browser, such as the INTERNET EXPLORER browser developed by MICROSOFT CORPORATION of Redmond, Wash. State), and a programmatic client 608 executing on respective client machines 610 and 612.

Turning specifically to the network-based marketplace 602, an Application Program Interface (API) server 614 and a web server 616 are coupled to, and provide programmatic and web interfaces respectively to, one or more application servers 618. The application servers 618 host one or more marketplace applications 620 and micro-transaction applications 622. The application servers 618 are, in turn, shown to be coupled to one or more databases servers 624 that facilitate access to one or more databases 626.

The marketplace applications 620 provide a number of marketplace functions and services to users that access the marketplace 602. The micro-transaction applications 622 provide educational services to improve the users' online reputation.

Further, while the system 600 shown in FIG. 6 employs a client-server architecture, the present application is of course not limited to such an architecture, and could equally well find application in a distributed, or peer-to-peer, architecture system. The various marketplace and micro-transaction applications 620 and 622 may also be implemented as standalone software programs which do not necessarily have networking capabilities.

The web client 606, it will be appreciated, may access the various marketplace and micro-transaction applications 620 and 622 via the web interface supported by the web server 616. Similarly, the programmatic client 608 accesses the various services and functions provided by the marketplace and micro-transaction applications 620 and 622 via the programmatic interface provided by the API server 614. The programmatic client 608 may, for example, be a seller application (e.g., the TURBOLISTER application developed by EBAY INC., of San Jose, Calif.) to enable sellers to author and manage listings in the marketplace 602 in an off-line manner, and to perform batch-mode communications between the programmatic client 608 and the network-based marketplace 602.

FIG. 6 also illustrates a third party application 628, executing on a third party server machine 630, as having programmatic access to the network-based marketplace 602 via the programmatic interface provided by the API server 614. For example, the third party application 628 may, utilizing information retrieved from the network-based marketplace 602, support one or more features or functions on a website hosted by the third party. The third party website may, for example, provide one or more promotional, marketplace or payment functions that are supported by the relevant applications of the network-based marketplace 602.

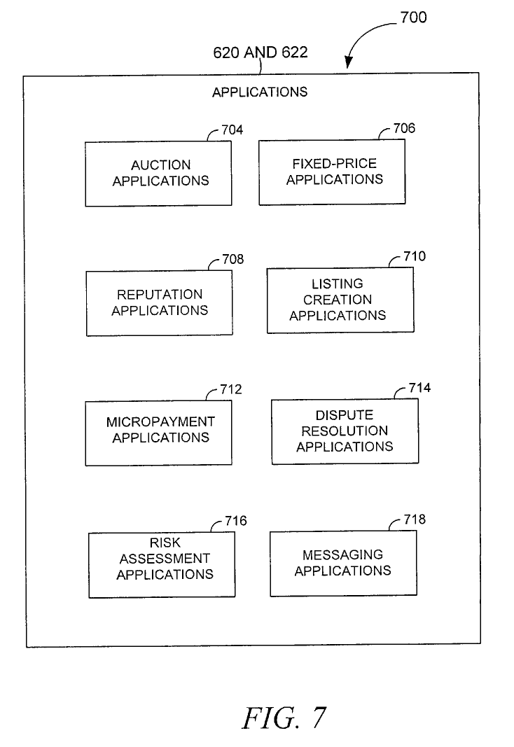

FIG. 7 is diagram illustrating multiple example marketplace and educational applications 700 that, in one example embodiment, are provided as part of the network-based marketplace 602. The marketplace 602 may provide a number of listing and price-setting mechanisms whereby a seller may group goods or services for sale, a buyer can express interest in or indicate a desire to purchase such goods or services, and a price can be set for a transaction pertaining to the goods or services.

The marketplace applications 620 are shown to include one or more auction applications 704 which support auction-format listing and price setting mechanisms (e.g., English, Dutch, Vickrey, Chinese, Double, Reverse auctions etc.). The various auction applications 704 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 706 support fixed-price listing formats (e.g., the traditional classified advertisement-type listing or a catalogue listing) and buyout-type listings. Specifically, buyout-type listings (e.g., including the Buy-It-Now (BIN) technology developed by EBAY INC., of San Jose, Calif.) may be offered in conjunction with an auction-format listing, and allow a buyer to purchase goods or services, which are also being offered for sale via an auction, for a fixed-price that is typically higher than the starting price of the auction.

Reputation applications 708 may allow parties that transact utilizing the network-based marketplace 602 to establish, build and maintain reputations, which may be made available and published to potential trading partners. Consider that where, for example, the network-based marketplace 602 supports person-to-person trading, users may have no history or other reference information whereby the trustworthiness and credibility of potential trading partners may be assessed. The reputation applications 708 may allow a user, for example through feedback provided by other transaction partners, to establish a reputation within the network-based marketplace 602 over time. Other potential trading partners may then reference such a reputation for the purposes of assessing credibility and trustworthiness.

Listing creation applications 710 may allow sellers conveniently to author listings pertaining to goods or services that they wish to transact via the marketplace 602.

Micro-transaction applications 712 may provide for users of the network-based marketplace 602 to participate in micro-transactions and have the micro-transaction applications 712 arrange for micropayment of transaction amounts related to micro-transactions transacted by the users. The micro-transaction applications may analyze transaction conditions (e.g., availability of a stored value 150, a valid bank account, an ACH funding 180, a valid credit card account 160, or a transaction risk assessment result associated with the user, and monetary value of the micro-transaction) and select a micropayment option for charging the transaction amount from a group of micropayment options based on the transaction conditions.

Dispute resolution applications 714 may provide mechanisms whereby disputes arising between transacting parties may be resolved. For example, the dispute resolution applications 714 may provide guided procedures whereby the parties are guided through a number of steps in an attempt to settle a dispute. In the event that the dispute cannot be settled via the guided procedures, the dispute may be escalated to a third party mediator or arbitrator.

Risk assessment applications 716 may allow the network-based marketplace 602 to take measures with respect to determining the trustworthiness of a user including analyzing, inter alia, the feedbacks received by the reputation applications 708 and to make assessments with respect to trustworthiness of the trading parties. The risk assessment applications may utilize other professional entities to profile the user in order to make the risk assessment regarding the user, in order to enable the micro-transaction applications 712 to make certain decisions.

Messaging applications 718 are responsible for the generation and delivery of messages to users of the network-based marketplace 602, such messages for example advising users regarding the status of listings at the marketplace 602 (e.g., providing “outbid” notices to bidders during an auction process or to provide promotional and merchandising information to users) or reminding them of certain actions that they may need to take in order to improve their online reputations.

### Example Machine Architecture

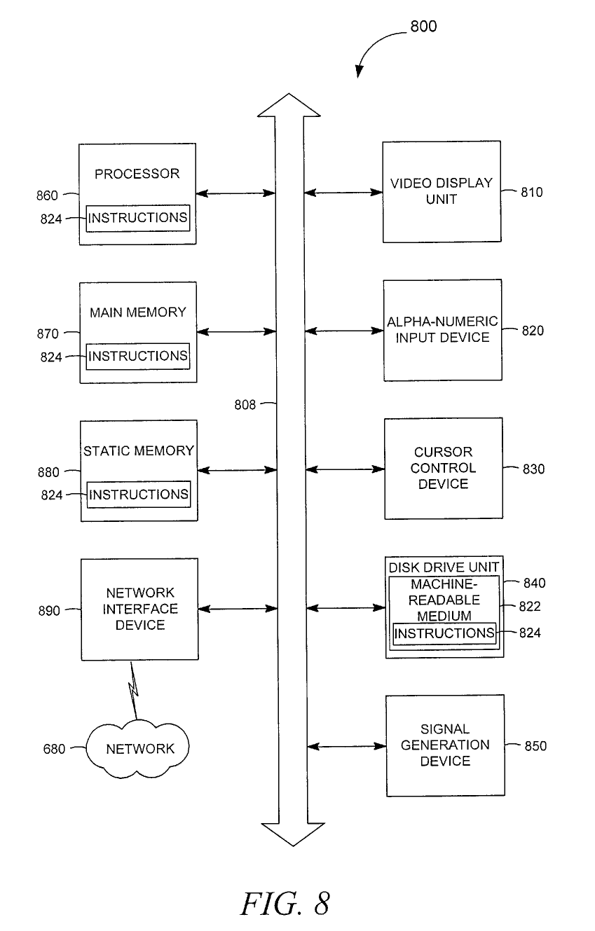

FIG. 8 is a block diagram illustrating a diagrammatic representation of machine 800 in the example form of a computer system within which a set of instructions for causing the machine to perform any one or more of the methodologies discussed herein may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 860 (e.g., a central processing unit (CPU) a graphics processing unit (GPU) or both), a main memory 870 and a static memory 880, which communicate with each other via a bus 808. The computer system 800 may further include a video display unit 810 (e.g., liquid crystal displays (LCD) or cathode ray tube (CRT)). The computer system 800 also may include an alphanumeric input device 820 (e.g., a keyboard), a cursor control device 830 (e.g., a mouse), a disk drive unit 840, a signal generation device 850 (e.g., a speaker) and a network interface device 890.

The disk drive unit 840 may include a machine-readable medium 822 on which is stored one or more sets of instructions (e.g., software 824) embodying any one or more of the methodologies or functions described herein. The software 824 may also reside, completely or at least partially, within the main memory 870 and/or within the processor 860 during execution thereof by the computer system 800, the main memory 870 and the processor 860 also constituting machine-readable media.

The software 824 may further be transmitted or received over a network 680 via the network interface device 890.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system for arranging for micropayment of transaction amounts related to micro-transactions transacted by a user have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
analyzing a transaction condition of a micro-transaction, the micro-transaction including a micropayment of a transaction amount;
selecting a micropayment option for charging the transaction amount from a group of micropayment options, based on the transaction condition; and
automatically applying the selected micropayment option for charging the transaction amount.

2. The method of claim 1, wherein the transaction condition is at least one of an availability of a stored value, an availability of a valid bank account associated with the user, an availability of an Automated Clearing House (ACH) funding to the user, a monetary value of the micro-transaction, an availability of a credit card account associated with the user, or a transaction risk assessment result.

3. The method of claim 1, wherein the group of micropayment options includes at least one of a stored value, a credit card charge, a balance transfer, an Automatic Clearing House (ACH) funding, an aggregation, or a forced pre-funding.

4. The method of claim 1, including determining that a stored value for the user is available and, based on the determination, deducting the transaction amount from the stored value for the user.

5. The method of claim 1, including determining that a valid credit card account associated with the user is available and based on the determination, charging the transaction amount to the valid credit card account associated with the user.

6. The method of claim 1, including determining that a valid bank account associated with the user is available and based on the determination, applying an instant balance transfer from the valid bank account associated with the user.

7. The method of claim 1, including determining that an ACH funding is available to the user and based on the determination, applying the ACH funding.

8. The method of claim 1, including determining that the user has a positive transaction risk assessment result and based on the determination, applying an aggregation.

9. The method of claim 1, including determining that a valid bank account associated with the user is available to the user and the user has a positive transaction risk assessment result, and based on the determination, applying a delayed balance transfer from the valid bank account associated with the user.

10. The method of claim 1, including determining that the user has a negative transaction risk assessment result, and based on the determination, applying a forced pre-funding.

11. The method of claim 1, including determining that a valid credit card account associated with the user is unavailable and based on the determination, forcing the user to upgrade to an ACH funding.

12. A system comprising:
a transaction analysis module to analyze a transaction condition of a micro-transaction, the micro-transaction including a micropayment of a transaction amount; and
a payment processor to:
select a micropayment option for charging the transaction amount from a group of micropayment options, based on the transaction condition; and
automatically apply the selected micropayment option for charging the transaction amount.

13. The system of claim 12, wherein the transaction analysis module is to analyze at least one of an availability of a stored value, an availability of a valid bank account associated with the user, an availability of an ACH funding to the user, a monetary value of the micro-transaction, an availability of a credit card account associated with the user, or a transaction risk assessment result.

14. The system of claim 12, wherein the group of micropayment options includes at least one of a stored value, a credit card charge, a balance transfer, an Automatic Clearing House (ACH) funding, an aggregation, or a forced pre-funding.

15. The system of claim 12, wherein the transaction analysis module is to determine that a stored value for the user is available and, based on the determination, the payment processor is to select a stored value option and to deduct the transaction amount from the stored value for the user.

16. The system of claim 12, wherein the transaction analysis module is to determine that a valid credit card account associated with the user is available and, based on the determination, the payment processor is to select a credit card charge option and to deduct the transaction amount from the valid credit card account associated with the user.

17. The system of claim 12, wherein the transaction analysis module is to determine that a valid bank account associated with the user is available and, based on the determination, the payment processor is to select a balance transfer option and to apply an instant balance transfer from the valid bank account associated with the user.

18. The system of claim 12, wherein the transaction analysis module is to determine that an ACH funding is available to the user and, based on the determination, the payment processor is to select an ACH funding option and to apply the ACH funding option.

19. The system of claim 12, wherein the transaction analysis module is to determine that the user has a positive transaction risk assessment result and, based on the determination, the payment processor is to select an aggregation option and to apply the aggregation option.

20. The system of claim 12, wherein the transaction analysis module is to determine that a valid bank account associated with the user is available and that the user has a positive transaction risk assessment result, and based on the determination, the payment processor module is to select a delayed balance transfer option and to apply a delayed balance transfer from the valid bank account associated with the user.

21. The system of claim 12, wherein the transaction analysis module is to determine that the user has a negative transaction risk assessment result and, based on the determination, the payment processor module is to select a forced pre-funding option and to apply the forced pre-funding option.

22. The system of claim 12, wherein the transaction analysis module is to determine that a valid credit card account associated with the user is unavailable and, based on the determination, the payment processor module is to force the user to upgrade to an ACH funding.

23. A machine-readable medium comprising instructions, which when implemented by one or more processors perform the following operations:
analyzing a transaction condition of a micro-transaction, the micro-transaction including a micropayment of a transaction amount;
selecting a micropayment option for charging the transaction amount from a group of micropayment options, based on the transaction condition; and
automatically applying the selected micropayment option for charging the transaction amount.

24. A system comprising:
means for analyzing a transaction condition of a micro-transaction, the micro-transaction including a micropayment of a transaction amount;
means for selecting a micropayment option for charging the transaction amount from a group of micropayment options, based on the transaction condition; and
means for automatically applying the selected micropayment option for charging the transaction amount.
